(19) United States
(12) Patent Application Publication
(10) Pub. No.: US 2021/0144810 A1
(43) Pub. Date: May 13, 2021

(54) PTC HEATING ELEMENT AND A PTC HEATING MODULE

(71) Applicant: Mahle International GmbH, Stuttgart (DE)

(72) Inventors: Marcel Huelss, Stuttgart (DE); Isabel Munoz Rubio, Stuttgart (DE); Falk Viehrig, Stuttgart (DE); Robin Wanke, Stuttgart (DE)

(21) Appl. No.: 17/066,479

(22) Filed: Oct. 8, 2020

(30) Foreign Application Priority Data
Oct. 9, 2019 (DE) 102019215470.0

(51) Int. Cl. H05B 1/02; B60H 1/22

(52) U.S. Cl. CPC H05B 1/0236; B60H 1/2218; H05B 2203/016; H05B 2203/023; H05B 2203/02

(57) ABSTRACT

A PTC heating element for a PTC heating module for a vehicle is disclosed. The PTC heating element includes a PTC thermistor having two main surface that, in a thickness direction of the PTC thermistor, are located opposite one another and spaced apart from one another. Two electrically conductive contact layers are applied to the two main surfaces of the PTC thermistor. A total quotient between a total geometrical area of the two contact layers and a total geometrical area of the two main surfaces is substantially below 1 and substantially above 0, e.g., between 0.05 and 0.85.

The invention relates to a PTC heating element for a PTC heating module for a vehicle according to the preamble of Claim 1. The invention also relates to a PTC heating module for a vehicle having at least one such PTC heating element.

PTC heating modules (PTC: positive temperature coefficient) are employed for heating up a fluid and can be employed in particular in a battery-electric vehicle for heating up passenger compartment air. The PTC heating module usually comprises multiple PTC heating elements which are electrically interconnected in parallel. The individual PTC heating element is formed of a PTC thermistor or a so-called PTC stone and electrically conductive contact layers applied to the same. By way of the contact layers, electric voltage is introduced into the PTC thermistor and because of this heat developed in the PTC thermistor. The same can then be passed on to the passenger compartment air.

There, the aim is to no longer operate new generations of the PTC heating modules only with 12V-48V vehicle systems but also directly in the high-voltage vehicle system of the battery-electric vehicle at the voltage level of the traction battery of 400V or 800V. When operating the PTC thermistor in the high-voltage vehicle system self-heating occurs and initially a reduction of its electrical resistance up to a minimum. The PTC thermistor in this range has a so-called NTC characteristic (NTC: negative temperature coefficient). At higher temperatures, the characteristic resistance increase in the PTC thermistor and thus the desired sudden down-regulation. The PTC thermistor is no operated in a so-called PTC range.

The transition between the NTC range and the PTC range of the PTC thermistors is the so-called transition point through which the PTC heating module has to pass whenever switched on. The maximum current developing in the transition point has to be taken into account when designing all components of the high-voltage vehicle system—such as for example conductor paths, conductor boards or PCBs (PCB: printed circuit board), bipolar transistors with insulated gate electrodes or IGBTs (IGBT: insulated-gate bipolar transistor), connectors etc. Here, the maximum current is dependent on the geometry and on the specific electrical resistance of the PTC thermistors.

Usually, the PTC heating module is provided for operation in a given voltage range and accordingly the resistance of the PTC thermistors is also designed for this voltage range. The wider the voltage range, the more difficult is it however to optimally configure the resistance of the PTC thermistors. In addition, the PTC heating element functions as condenser because of its construction. Because of this, the PTC heating module causes capacity-related current and thus also voltage peaks during the power regulation by means of the pulse width modulation. These can subject the high-voltage vehicle system of the battery-electric vehicle to major loads.

The sum total of the loads of the high-voltage vehicle system caused by the PTC module or the PTC heating elements threatens the uninterrupted operation of the battery-electric vehicle.

The object of the invention therefore is to state for a PTC heating element of the generic type an improved or at least alternative embodiment with which the described disadvantages are overcome. A further object of the invention is to provide a suitably improved PTC heating module having at least one such PTC heating element.

According to the invention, these objects are solved through the subject of the independent claims. Advantageous embodiments are subject of the dependent claims.

The present invention is based on the general idea of reducing the maximum electric current density during the heating-up of a PTC heating element and thereby of a PTC heating module to a necessary minimum and in this way minimise the loading of the electrical system of the vehicle.

A PTC heating element is provided for a PTC heating module for a vehicle. In particular, the vehicle can be a battery-electric vehicle. The PTC heating element comprises a PTC thermistor with two main surfaces which, in a thickness direction of the PTC thermistor, are arranged located opposite one another and spaced from one another. Usually, the main surfaces of the PTC thermistor are orientated parallel to one another. Usually, the PTC thermistor is rectangular. A thickness of the PTC thermistor is defined in the thickness direction by a distance of the two main surfaces from one another. The PTC heating element additionally comprises two electrically conductive contact layers which are each applied to the main surfaces of the PTC thermistor. The PTC thermistor is thus arranged in the thickness direction between the two contact layers and connected to these in an electrically conductive manner. The PTC heating element is provided for heating-up a fluid—in particular air. The PTC thermistor can be formed of a PTC ceramic. The electrically conductive contact layers are connected to the PTC thermistor in an electrically conductive manner so that the PTC thermistor, via the contact layers, can be incorporated in an electrical supply circuit and supplied with voltage. With the applied voltage, the PTC thermistor can heat up and give off developed heat to the heat exchanger to the fluid—i.e. liquid or air. According to the invention, a total quotient between a total geometrical area of the contact layers and a total geometrical area of the main surfaces is substantially below 1 and substantially above 0.

The term “total quotient” is equivalent to the terms “quotient” and “ratio”. The term “substantially” in the context of the present invention signifies that the entire geometrical area of the contact layers and the entire geometrical area of the main surfaces deviate from one another by maximally 85% and by at least 5%. Thus, the total quotient is between 0.05 and 0.85. The main surfaces are then altogether covered with the total quotient equal to 0.85 at 85% and with the total quotient equal to 0.05 at 5%. The respective contact layer is preferentially contiguous and has the shape of a flat geometrical figure which can be both convex and also concave. Preferentially, the respective contact layer has the shape of a convex or concave polygon. Preferentially, the respective contact layer is evenly distributed on the respective main surface so that in the PTC thermistor or at least in the interior regions of the PTC thermistor even conditions are present.

Because of the fact that the main surfaces of the PTC thermistor are not completely covered with the contact layers, the capacity of the PTC heating element, compared with a conventional PTC heating element having an identical PTC thermistor with completely covered main surfaces, is reduced. Because of this, capacity-related current and because of this also voltage peaks can be reduced compared with a conventional PTC heating element. The total quotient should be selected within the given value range so that the desired effect occurs in the desired intensity.

Because of the construction of the PTC thermistor, the two main surfaces of the PTC thermistor are equal in size and have the same geometrical area. The total quotient can be defined and matched through the geometrical areas of the respective contact layers. Two PTC heating elements according to the invention can then have identical PTC thermistors but are distinct because of the selected total quotient. When the total quotient in the given value range is reduced or increased, the main surfaces of the PTC thermistors are covered with the contact layers to a different degree. Because of this, the capacity of the PTC heating element can be adapted and capacity-related current and thus also voltage peaks reduced.

Advantageously it can be provided that the total quotient is between 0.1 and 0.8, preferably between 0.2 and 0.7, more preferably between 0.2 and 0.5 and even more preferably between 0.3 and 0.5. In the value range of the total quotient between 0.1 and 0.8, the capacity of the PTC heating element and thus the capacity-related current and thus also voltage peaks can be noticeably reduced. This effect is particularly noticeable in the value range of the total quotient between 0.2 and 0.7. In the value range of the total quotient between 0.2 and 0.5, the thickness of the PTC heating element can be reduced without the utilisation conditions changing noticeably. Furthermore, in the value range of the total quotient between 0.3 and 0.5, the heating output can be noticeably improved. Thus, dependent on the selected value range of the total quotient, individual or multiple characteristics of the PTC heating element can be adapted.

Advantageously, quotients between the geometrical surfaces of the respective contact layers and the respective main surfaces assigned to these can differ from one another in the two electrically conductive contact layers. In other words, the two main surfaces can be covered with the respective contact layer to a different degree. The total quotient between the total geometrical area of the contact layers and the total geometrical area of the main surfaces can remain unchanged however. Because of this, a further optimisation of the characteristics of the PTC heating element can take place. When the main surfaces of the PTC thermistor are equal in size, the total quotient is two times smaller than the sum of the two abovementioned quotients.

In an advantageous further development of the PTC heating element it is provided that a distance of the two contact layers from one another is greater in at least some interior regions of the PTC thermistor than the thickness of the PTC thermistor. In other words, the distance of the two contact layers from one another is greater than a distance of the main surfaces of the PTC thermistor from one another. The two contact layers cannot overlap one another in the thickness direction of the PTC thermistor at least in some interior regions of the PTC thermistor. In other words, the contact layers in interior regions of the PTC thermistor can be applied offset relative to one another transversely to the thickness direction. When the two contact layers do not overlap in the thickness direction of the PTC thermistor, the distance between these can no longer be defined parallel to the thickness direction and because of this is greater than the thickness of the PTC thermistor.

The distance is always defined by the shortest distance of the two contact layers from one another. The interior regions of the PTC thermistor are regions which are spaced apart from its lateral surfaces and because of this are arranged centrally in the PTC thermistor. The lateral surfaces extend on the edge side from the one main surface to the other main surface and together with these demarcate the PTC thermistor towards the outside. If the PTC thermistor is cuboid, the PTC thermistor altogether has four lateral surfaces which are orientated perpendicularly to the main surfaces and in pairs perpendicularly to one another. Moreover, the interior regions are distinct from the edge regions, in which characteristics of the PTC thermistor are influenced by edge effects developing on the lateral surfaces.

When the distance of the contact layers deviates from the thickness of the PTC thermistor, the effective current path for electrons is increased and the capacity of the PTC heating element reduced. The capacity-related current and because of this also voltage peaks can accordingly be reduced. This effect can be achieved in particular in the value range of the total quotient between 0.2 and 0.5, since the distance between the contact layers in all interior regions of the PTC thermistor can then be increased. Accordingly, the thickness of the PTC thermistor can be reduced without its utilisation characteristics changing noticeably.

In an advantageous further development of the PTC heating element it is provided that the respective contact layer comprises a comb structure. The comb structure then comprises multiple contact strips that are spaced apart from one another and are arranged parallel to one another, which are contiguous on one side or both sides. Thus, the contact layer remains contiguous but does not completely cover the main surface of the PTC thermistor. The comb structure makes possible an equally distributed contacting of the main surface of the PTC thermistor as a result of which the heating output of the PTC heating element can be improved. This effect is noticeable in particular in the value range of the total quotient between 0.3 and 0.5. Here, the comb structure can be adapted dependent on the desired characteristics of the PTC heating element or dependent on the desired total quotient. It is conceivable for example that the contact strips of the respective comb structure are arranged at an uneven distance from one another. It is also conceivable that the contact strips of the respective comb structure have a width and/or length that deviates from one another. In addition it is conceivable that a width of the respective contact strip is smaller or even greater than its distance from at least one of the adjacent contact strips.

Advantageously it can be additionally provided that the two contact layers each have the comb structure. The respective comb structures are then applied to the main surfaces of the PTC thermistor in such a manner that the respective contact strips of the two comb structures are parallel to one another. At least some contact strips of the one comb structure is faced by no contact strips of the other comb structure. In other words, the comb structures do not overlap in the thickness direction at least in regions. Because of this, as already explained above, the distance between the contact layers can be greater than the thickness of the PTC thermistor. The advantages described above can be achieved accordingly.

Alternatively to the comb structure, the respective contact layer can comprises a volute structure. The volute structure then comprises multiple windings which emanate from the centre of the main surface and cover the same as far as to the lateral surfaces. Here, too, both contact layers can have the volute structure. The two volute structures are then applied to the main surfaces of the PTC thermistor in such a manner that the respective windings of the two volute structures do not overlap in the thickness direction. Because of this, the distance between the two contact layers can, in the same way, be greater, at least in some interior regions of the PTC thermistor, than the thickness of the PTC thermistor. The advantages described above can thereby be achieved in the same way.

It is also conceivable that the contact layers, individually or in pairs, also have structures that deviate from the comb structure and from the volute structure. As already explained above, the respective contact layer has the shape of a flat geometrical figure which can be both convex and also concave. Preferentially, the respective contact layer has the shape of a convex or concave polygon.

The invention also relates to a PTC heating module for a vehicle having at least one PTC heating element described above. In particular, the vehicle can be a battery-electric vehicle. There, the one contact layer of the respective PTC heating element is connected to a positive terminal contact and the other contact layer of the respective PTC heating element to a negative terminal contact in an electrically conductive manner. In particular, the PTC heating module can comprise multiple PTC heating elements which are electrically interconnected parallel to one another.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

It shows, in each case schematically

FIG. 1 a view of a PTC heating element according to the invention;

FIG. 2 a sectional view of the PTC heating element shown in FIG. 1 through a section plane A-A shown in FIG. 1;

FIGS. 3 and 4 plan views of main surfaces of the PTC heating element shown in FIG. 1;

FIG. 5 a plan view of a main surface of the PTC heating element in a further embodiment;

FIG. 6 a sectional view of the PTC heating element shown in FIG. 5 through a section plane B-B shown in FIG. 5;

FIG. 7 a plan view of a main surface of the PTC heating element in a further embodiment;

FIG. 8 a sectional view of the PTC heating element shown in FIG. 1 through a section plane C-C shown in FIG. 7;

FIG. 9 a plan view of a main surface of the PTC heating element in a further embodiment;

FIG. 10 a sectional view of the PTC heating element shown in FIG. 9 through a section plane D-D shown in FIG. 9;

FIG. 11 a view of the arrangement of both contact layers of the PTC heating element in a further embodiment;

FIG. 12 a sectional view of the PTC heating element shown in FIG. 11 through a section plane E-E shown in FIG. 12.

FIG. 1 shows a view of a PTC heating element 1 according to the invention for a PTC heating module for a vehicle. The PTC heating element 1 comprises a PTC thermistor 2, which is produced for example from a PTC ceramic. Here, the PTC thermistor 2 is cuboid and has two main surfaces 3a and 3b, which in a thickness direction DR are located opposite one another and spaced apart from one another. A distance of the two main surfaces 3a and 3b from one another defines a thickness D_{PTC} of the PTC thermistor 2. Furthermore, the PTC thermistor 2 has four lateral surfaces 5 which, to both its main surfaces 3a and 3b and in pairs are perpendicular to one another. The lateral surfaces 5 connect the main surfaces 3a and 3b on the edge side with one another and, together with these, demarcate the PTC thermistor 2 towards the outside. FIG. 2 now shows a sectional view of the PTC heating element 2 shown in FIG. 1 through the section plane A-A. FIGS. 3 and 4 show plan views of the main surfaces 3a and 3b of the PTC heating element 1 shown in FIG. 1.

Furthermore, the PTC heating element 1 comprises two electrically conductive contact layers 4a and 4b which are applied to the respective main surfaces 3a and 3b of the PTC thermistor 1. The respective contact layer 4a and 4b respectively is contiguous but does not completely cover the respective main surface 3a and 3b respectively of the PTC thermistor 2. The respective contact layer 4a and 4b respectively has a geometrical area F_{4A} and F_{4B} respectively and the respective main surface 3a and 3b respectively has a geometrical area F_{3A} and F_{3B} respectively. A quotient Q_{A} and Q_{B} respectively of the respective geometrical area F_{4A} and F_{4B} respectively and of the respective geometrical area F_{3A} and F_{3B} is below 1 and above 0. Thus the following applies:

Q_{A}=F_{4A}/F_{3A} and 0<Q_{A}<1

Q_{B}=F_{4B}/F_{3B} and 0<Q_{B}<1.

A total geometrical area F₄ of the contact layers 4a and 4b is then the sum of the two areas F_{4A} and F_{4B}. Then, a total geometrical area F₃ of the main surfaces 3a and 3b is the sum of the geometrical areas F_{3A} and F_{3B}. A total quotient Q between the total geometrical areas Fa and F₃ is substantially below 1 and substantially above 0. Thus the following applies:

Q=F₄/F₃=(F_{4A}+F_{4B})/(F_{3A}+F_{3B}) and 0<Q<1.

By way of the contact layers 4a and 4b, the PTC heating element 1 can be incorporated in an electrical supply circuit and supplied with voltage. Accordingly, the contact layers 4a and 4b are then each assigned a positive terminal and a negative terminal. In this direction DR between the two electrically conductive contact layers 4a and 4b the PTC thermistor 2 is arranged so that the PTC heating element 1 forms a condenser in the supply circuit.

The two contact layers 4a and 4b—see in particular FIG. 3 and FIG. 4—each have a comb structure 6a and 6b. In this exemplary embodiment, the comb structures 6a and 6b are configured so that the respective quotient Q_{A} and Q_{B} respectively is equal to 0.5. Accordingly, the total quotient Q is also equal to 0.5. However it is also conceivable that the two quotients Q_{A} and Q_{B} deviate from one another and/or from 0.5. It is also conceivable that the total quotient Q deviates from 0.5. The respective comb structure 6a and 6b respectively then comprises multiple contact strips 7a and 7b respectively, which are each contiguous on one side. The contact strips 7a and 7b respectively are arranged parallel to one another and spaced apart from one another. The two contact layers 4a and 4b and the two comb structures 6a and 6b respectively are applied to the main surfaces 3a and 3b in such a manner that the contact strips 7a and the contact strips 7b—see in particular FIG. 2—are orientated parallel to one another. Furthermore, the contact strips 7a and the contact strips 7b do not overlap in the thickness direction DR. To this end, the two comb structures 6a and 6b are arranged rotated relative to one another about a centre axis MA of the PTC thermistor 1 by 180°. The centre axis MA is orientated parallel to the thickness direction and passes through the centre of the respective PTC thermistor 2.

In the PTC heating element 1 shown here, the geometrical area F_{4A} and F_{4B} respectively of the contact layers 4a and 4b is reduced compared with a conventional PTC heating element with an identical PTC thermistor, as a result of which the capacity of the PTC heating element 1 is also reduced.

Advantageously, compared with a conventional PTC heating element, capacity-related current and because of this also voltage peaks in the PTC heating element 1 can be reduced because of this. This effect is already noticeable in a value range of the total quotient Q between 0.1 and 0.8 and particularly intensively in a value range of the total quotient Q between 0.2 and 0.7. Here, the total quotient Q equal to 0.5 is merely chosen exemplarily. In addition, the contact layers 4a and 4b are evenly distributed over the respective main surfaces 3a and 3b as a result of which the heating output of the PTC heating element 1 is noticeably improved. This effect is noticeable in particular in a value range of the total quotient Q between 0.3 and 0.5. The total quotient Q equal to 0.5 is merely chosen exemplarily here.

FIG. 5 shows a plan view of the main surface 3a and 3b respectively of the PTC heating element 1 in a further embodiment. In FIG. 6, a sectional view of this PTC heating element 1 through a section plane B-B shown in FIG. 5 is shown. Here, the contact strips 7a and 7b respectively of the comb structure 6a and 6b respectively, deviating from FIG. 1 to FIG. 4, are contiguous on both sides. The comb structures 6a and 6b are each applied adjacent to two adjacent lateral surfaces 5. The comb structures 6a and 6b are identical and arranged rotated about the centre axis MA of the PTC thermistor 2 relative to one another by 180°—see in particular FIG. 6. Because of this, the contact strips 7a and 7b and the contact layers 4a and 4b respectively do not overlap in the thickness direction DR in the interior regions 8 of the PTC thermistor 2.

FIG. 7 shows a plan view of the main surface 3a and 3b respectively of the PTC heating element in a further embodiment. FIG. 8 shows a sectional view of the PTC heating element 1 through a section plane C-C shown in FIG. 7. Here, the respective comb structure 6a and 6b respectively is identical to the respective comb structure 6a and 6b respectively from FIG. 5 and FIG. 6, but is deviatingly arranged on the main surface 3a and 3b respectively. Here, the comb structures 6a and 6b are each applied adjacent to one of the lateral surfaces 5. The two comb structures 6a and 6b are arranged rotated relative to one another about the centre axis MA of the PTC thermistor 2 by 180°. Because of this, the contact strips 7a and 7b respectively do not overlap the contact layers 4a and 4b in the thickness direction DR in the interior regions 8 of the PTC thermistor 2.

FIG. 9 shows a plan view of the main surface 3a and 3b respectively of the PTC heating element 1 in a further embodiment. FIG. 10 shows a sectional view of this PTC heating element 1 through a section plane D-D shown in FIG. 9. Here, the two comb structures 6a and 6b are identical to one another, wherein one of the contact strips 7a and 7b respectively has a greater width than other contact strips 7a and 7b respectively. Here, the comb structures 6a and 6b are each applied centrally. The two comb structures 6a and 6b are arranged rotated about the centre axis MA of the PTC thermistor 2 relative to one another by 180°. Because of this, the contact strips 7a and 7b or the contact layers 4a and 4b do not overlap in the thickness direction DR in interior regions 8 of the PTC thermistor 2.

The quotients Q_{A} and Q_{B} with the PTC heating elements 1 in FIG. 5 to FIG. 10 each amount to 0.5. The total quotient Q also amounts to 0.5. The same advantages as in the PTC heating element 1 from FIG. 1 to FIG. 4 are achieved with the PTC heating elements 1 shown here.

FIG. 11 shows a view of the PTC heating element 1 in a further embodiment. In FIG. 11, the PTC thermistor 2 is shown transparently, so that the two contact layers 4a and 4b are visible. FIG. 12 shows a sectional view of this PTC heating element 1 through a section plane E-E shown in FIG. 12. In this embodiment, the respective contact layer 4a and 4b respectively each has the comb structure 6a and 6b respectively, which is similar to the respective comb structure 6a and 6b in FIG. 1 to FIG. 4. The quotient Q_{A} and Q_{B} as well as the total quotient Q however are each equal to 0.3 here. Here, the two comb structures 6a and 6b are arranged in such a manner that the respective contact strips 7a and 7b do not overlap in the thickness direction DR. To this end, the two comb structures 6a and 6b are arranged rotated relative to one another about the centre axis MA of the PTC thermistor 2 by 180°.

A distance DAB of the two contact layers 4a and 4b relative to one another is greater than the thickness D_{PTC} of the PTC thermistor 2 here. Because of this, the effective current path for electrons is increased and the capacity of the PTC heating element 1 reduced. The capacity-related current and because of this also voltage peaks can accordingly be reduced. Accordingly, the thickness D_{PTC} of the PTC thermistor 2 can also be reduced without its utilisation characteristics changing noticeably. This effect can be achieved in particular in the value range of the total quotient Q between 0.2 and 0.5. The total quotient Q equal to 0.3 is merely chosen exemplarily here.

1. A PTC heating element for a PTC heating module for a vehicle, comprising:
a PTC thermistor having two main surfaces, the two main surfaces in a thickness direction of the PTC thermistor are located opposite one another and spaced apart from one another,
two electrically conductive contact layers that are each applied to the two main surfaces of the PTC thermistor,
wherein a total quotient between a total geometrical area of the two contact layers and a total geometrical area of the two main surfaces is substantially below 1 and substantially above 0.

2. The PTC heating element according to claim 1, wherein the total quotient is between 0.1 and 0.8.

3. The PTC heating element according to claim 1, wherein respective quotients between respective geometrical areas of the two contact layers and respective geometrical areas of the main surfaces assigned to these differ from one another in the two contact layers.

4. The PTC heating element according to claim 1, wherein a distance of the two contact layers from one another, at least in some interior regions of the PTC thermistor, is greater than a thickness of the PTC thermistor.

5. The PTC heating element according to claim 1, wherein the two contact layers do not overlap in the thickness direction of the PTC thermistor at least in some interior regions of the PTC thermistor.

6. The PTC heating element according to claim 1, wherein at least one of the two contact layers has a comb structure including contact strips that are arranged spaced apart from one another and parallel to one another, and wherein the contact strips are contiguous on one side or both sides.

7. The PTC heating element according to claim 6, wherein at least one of:
the contact strips of the comb structure of the at least one of the two contact layers are arranged at an uneven distance from one another,
the contact strips of the comb structure of the at least one of the two contact layers have at least one of a width and a length that deviates from one another, and
a width of at least one of the contact strips is smaller or greater than its distance from at least one of the adjacent contact strips.

8. The PTC heating element according to claim 6, wherein:
the two contact layers each have the comb structure, wherein the respective comb structures are applied to the two main surfaces of the PTC thermistor such that the contact strips of the two comb structures are parallel to one another, and
at least some of the contact strips of one of the comb structures do not locate opposite to any contact strips of the other of the comb structures.

9. The PTC heating element according to claim 1, wherein at least one of the two contact layers has a volute structure.

10. A PTC heating module for a vehicle, comprising: at least one PTC heating element, the at least one PTC heating element including:
a PTC thermistor having two main surfaces that are located opposite one another and spaced apart from one another in a thickness direction of the PTC thermistor,
two electrically conductive contact layers that are each applied to the two main surfaces of the PTC thermistor,
wherein a total quotient between a total geometrical area of the two contact layers and a total geometrical area of the two main surfaces is between 0.05 and 0.85,
wherein one of the two contact layers of the at least one PTC heating element is connected to a positive terminal contact and the other of the two contact layers of the at least one PTC heating element is connected to to a negative terminal contact in an electrically conductive manner.

11. The PTC heating module according to claim 10, wherein the total quotient is between 0.1 and 0.8.

12. The PTC heating module according to claim 10, wherein the total quotient is between 0.2 and 0.7.

13. The PTC heating module according to claim 10, wherein the total quotient is between 0.2 and 0.5.

14. The PTC heating module according to claim 10, wherein the total quotient is between 0.3 and 0.5.

15. The PTC heating module according to claim 10, wherein at least one of the two contact layers has a comb structure including a plurality of contact strips arranged spaced apart from one another and parallel to one another.

16. The PTC heating module according to claim 15, wherein the plurality of contact strips of the comb structure are arranged at an uneven distance from one another.

17. The PTC heating module according to claim 15, wherein the plurality of contact strips of the comb structure have at least one of a width and a length that deviates from one another.

18. The PTC heating module according to claim 15, wherein a width of at least one of the plurality of contact strips of the comb structure is smaller or greater than its distance from an adjacent one of the plurality of contact strips.

19. The PTC heating element according to claim 1, wherein the total quotient is between 0.05 and 0.85.

20. The PTC heating element according to claim 19, wherein the total quotient is between 0.2 and 0.7.
